(19) United States
(12) Patent Application Publication
(10) Pub. No.: US 2017/0032297 A1
(43) Pub. Date: Feb. 2, 2017

(54) Systems and Methods for Increasing Capability of Systems of Business Through Maturity Evolution

(71) Applicants: Dale Chalfant, Troy, MI (US); Paul Vereycken, Troy, MI (US); Antonina Jones, Troy, MI (US); James Britt, Troy, MI (US); Dawn Mclaughlin, Troy, MI (US); Greater Brain Group Inc., Troy, MI (US)

(72) Inventors: Dale Chalfant, Troy, MI (US); Paul Vereycken, Troy, MI (US); Antonina Jones, Troy, MI (US); James Britt, Troy, MI (US); Dawn Mclaughlin, Troy, MI (US)

(21) Appl. No.: 15/301,490

(22) PCT Filed: Apr. 3, 2015
(86) PCT No.: PCT/US2015/024271

§ 371 Date: Oct. 3, 2016

Related U.S. Application Data
(60) Provisional application No. 61/974,806, filed on Apr. 3, 2014.
(60) Provisional application No. 62/080,192, filed on Nov. 14, 2014.

(51) Int. Cl. G06Q 10/06

(52) U.S. Cl. CPC G06Q 10/0637; G06Q 10/0631

(57) ABSTRACT

A method for assessing at least one capability or maturity of a business entity, the method comprising the steps of integrating information gathered regarding current capability of a business or at least one business unit into an evaluation engine that assesses inputted information based on at least one capability criteria; producing at least one output that indicates evolved capability value, wherein said evolved capability value is either produced directly from the capability generator or is mediated by at least one evolution evaluator assessment resident in an evolution pack; transferring the output to a report, the report including at least one current maturity diagram and/or action recommendation output.

The present invention is a continuation of U.S. Provisional Application Ser. No. 61/974806, filed Apr. 3, 2014, and U.S. Provisional Application Ser. No. 62/080,192 filed Nov. 14, 2014, and claim priority to both. The specifications of both are incorporated by reference herein in their entireties.

### BACKGROUND

The present disclosure relates generally to a system and method to identify and facilitate maturation of the capabilities of a business or other entity. More particularly, the present pertains to an apparatus and an associated method facilitates capability increases of one or more systems employed by business or other entity through maturity evolution and provide the interested business or entity with at least one tangible report or action item regarding the same.

Various assessment tools exist to assist businesses implementing change, increasing productivity and/or providing forward-planning tools for use in the ongoing enterprise. To date, such tools have been less than successful in providing repeatable guidance-based on input criteria. Heretofore, enterprises have not been provided with multidimensional tools that can be employed to assess the current state of an organization and generate solutions for future activities that are specific tailored to the mission and goals of the particular organization.

It would be desirable to provide a method and system that can be readily utilized to assess the present state of an organization or entity and to produce a discernable solution set and/or recommendation set. It would also be desirable to provide a system and method that would provide repeatable guidance-based on input criteria that would be useful to the associated business in assessing and managing its growth and maturity.

### SUMMARY

A method for assessing at least one capability or maturity of a business entity, the method comprising the steps of integrating information gathered regarding current capability of a business or at least one business unit into an evaluation engine that assesses inputted information based on at least one capability criteria; producing at least one output the indicates evolved capability value, wherein said evolved capability value is either produced directly from the capability generator or is mediated by at least one evolution evaluator assessment resident in an evolution pack; transferring the output to a report, the report including at least one current maturity diagram and/or action recommendation output.

The current maturity diagram as disclosed herein includes a matrix having at least one region associated with at least one of the following: ad hoc capacity, emergent technology, managed technology and optimized technology cross-indexed against at least one attribute selected from the following: process attributes, technology attributes, human resource attributes.

### BRIEF DESCRIPTION OF THE DRAWING

The description herein makes reference to the accompanying drawings in which like reference numerals refer to like parts throughout the several views and wherein:

FIG. 1—is a graphic depiction of an evolution pack whose effectuation is created pursuant to operations of an embodiment as described herein;

FIG. 2.—is a graphic depiction a capability maturity engine operable pursuant various embodiments as described herein;

FIG. 3—is a graphic depiction of a process operation of the validator according to various embodiments as described herein;

FIG. 4—is a graphic depiction of a process operation of the evaluator according to various embodiments as described herein;

FIG. 5—is a graphic depiction of a process operation of the transformer according to various embodiments as described herein;

FIG. 6—is a graphic depiction of process operation of a scheduler according to various embodiments as described herein;

FIG. 7—is a graphic depiction of an operation of an current maturity diagram generator according to various embodiments of the present invention described herein;

FIG. 8—is a graphic depiction of a process operation of a packager according to various embodiments of the present invention described herein;

FIG. 9—is a block diagram of an example of a server which may be used in the system or stand-alone according to various embodiments described herein;

FIG. 10—is a block diagram of a client device according to various embodiments described herein;

FIG. 11 is a depiction of an embodiment of an current maturity diagram generated by the process disclosed herein; and

FIG. 12 is a depiction of an embodiment of a representative current maturity diagram as outputted by the process and program as disclosed herein.

### DETAILED DESCRIPTION

Disclosed herein are a system, method and apparatus that can assemble various inputs pertaining to a business and produce a report assessing organizational maturity based on multiple indicators. The report can be interactive and relational across the multiple indicators and can include at least one current maturity diagram that describes or otherwise identified the current maturity of the business enterprise under study and can provide further basis for future action and decisions within and regarding the business entity with the goal that the business or other entity can become more agile and mature. The current maturity diagram so generated can be further employed in the process disclosed herein to produce a charter that provides a verbal or graphic representation of one or more actions that should be taken by the entity under study to achieve its vision by outlining one or more strategic or tactical initiatives. The system, method and process as disclosed herein can generate entity specific initiative options and metrics that can be used to guide the business entity through decision processes which can result in more mature business capabilities processes. Such capabilities are typically a function of a combination of people process and technology both existing and proposed that, when assembled together, create value in the provision of a product or service.

The system, method and apparatus as disclosed herein can facilitate transformation of maturation of capabilities of an associated business and, where desired or required, can provide detailed guidance on maturation of the business in question. In one aspect the system, method and apparatus may collect and integrate assessment inquiries that can be contained in suitable questionnaires, including but not limited to, assessment questionnaires, charter questionnaires and the like. Assessment inquiries can also be derived from data collected as the inventory of people, roles and skills, processes and technology, and information regarding existing and new issues and initiatives relating to capability, their metrics and sequencing are validated against existing information stores and knowledge bases.

In other aspects, responses to the assessment inquiries can be validated to assure accuracy and relevancy. In certain embodiments, validated responses to capability maturity assessment questionnaires and a charter questionnaires and the like can be evaluated. Similarly, validated inventory of people, roles and skills, processes and technology can be evaluated. Validated information regarding existing and new issues and initiatives, their metrics and sequencing can also be evaluated and integrated onto the process as disclosed herein. When a business, or other, entity contemplates maturing their capabilities, it is important to consider people, process, and technology aspects. The evaluator examines knowledge bases and information stores to provide information regarding the current maturity of each capability.

In certain embodiments, a transformation process step of the assessment is further provided. The transformation process step can utilize results of the evaluation process step and compares this against knowledge bases and patterns to determine gaps and mismatches that exist in capability maturity. These determined gaps can be transformed into initiatives along with their corresponding metrics.

In certain embodiments of the system, method and process as disclosed herein, a planner or scheduler is provided. The planner scheduler can use initiatives selected from suggestion data generated in the transformer and/or metrics and sequencing results data derived from the evaluator to generate at least one output roadmap outlining identify and sequence of future actions in at least one action plan output.

Various embodiments of the system, method and process as disclosed in this application can include a current maturity diagram generator. The current maturity diagram generator can be configured to take responses as from the capability assessment questionnaire and represent the data in a pictorial output that represents the current capability maturity and highlights areas in which enterprise maturity is lacking. In various embodiments, the system, method or process as disclosed herein can include a packager that is configured to employ assessment materials to create an evolution pack that comprises information from the current maturity diagram generator, the business charter and planner activities that is outputted as a report or reports to the business.

Where desired or required, the process can include a governance module is provided. The governance module can act on the assessment output data to realize results of capability maturity assessment operations and compare the results with actual results. The governance process is configured in a feedback arrangement and its use improves the capability maturation operations.

Thus there is disclosed a capability maturity engine that generates guidance representative of the maturation of a business. Inputs to the capability maturity engine can include, but are not limited to, a capability maturity assessment questionnaire, a charter questionnaire, inventory of business applications and technology, inventory of business processes, inventory of people's roles and competencies, which encompass skills and experience, information regarding issues and initiatives relating to capability, their metrics and sequencing. Once the input indicia are provided, capability maturity can be evaluated. The evaluation first makes assessment of the current capabilities and initiatives, then, on a capability-by-capability basis, comparison is made with knowledge bases of capabilities and sequencing. Responsive to the performed evaluations, initiatives that are recommended and/or requires are derived to address gaps and are planned accordingly. A decision maker is then able to make use of this strategic planning information along with a current maturity state diagram to most effectively use resources to mature capability of a business, or other, entity.

Through utilization of the capability maturity engine, a mechanism is provided that evaluates current capabilities and initiatives and whose use permits acceleration of the maturation of capability. The capability maturity engine provides an adaptable, yet repeatable, mechanism by which accurately to plan initiatives. The assessment procedures carried out by the capability maturity engine, are adaptable, expandable to provide for assessment of other capabilities as well as altering assessment criteria and procedures.

In these and other aspects, therefore, apparatus, and an associated method, is provided by which to facilitate transformation of maturation of a business or other entity's capabilities through output including, but not limited to, reports and graphic depictions such as business specific insightful diagrams.

In various embodiments, the system, method and process can include a governance process module or architecture that may utilize results of capability maturity assessment operations and compare the results with actual results either historic, realtime or future. The governance process may be configured in a feedback arrangement and may be employed to improve capability maturation operations such as those progressing in the system, method or process as described herein.

A capability engine or module can also be provided that generates guidance representative of the maturation of business capacity or capabilities. Inputs to the capability maturity engine may include but is not limited to one or more of the following: one or more capability maturity assessment questionnaires, one or more charter questionnaires, one or more inventories of business applications and technology, one or more inventories of business processes, one or more inventories of people's roles and competencies that may encompass skills and experience, information regarding business-relevant issues and initiatives relating to business capability and/or their metrics and sequencing.

The provided input indicia can be subjected to suitable evaluation to identify and quantify capability maturity of the associated business or enterprise. The evaluation process can include an initial or first assessment of the current business capabilities and initiatives. Once current business capabilities and initiatives are assessed, the process can proceed to perform a capability-by-capability evaluation comparison with knowledge bases of capabilities and sequencing being employed. Responsive to the performed evaluations, needed initiatives are derived to address identified capability gaps and are scheduled accordingly. A decision maker or interested party is then able to make use of this strategic planning information along with a business specific process—generated insightful diagram to most effectively use resources to mature capability of a business.

Through utilization of the capability maturity engine, a mechanism is provided that evaluates current capabilities and initiatives and whose use permits acceleration of the maturation of capability. The capability maturity engine provides an adaptable, yet repeatable, mechanism by which accurately to schedule initiatives. The assessment procedures carried out by the capability maturity engine, are adaptable, expandable to provide for assessment of other capabilities as well as altering assessment criteria and procedures

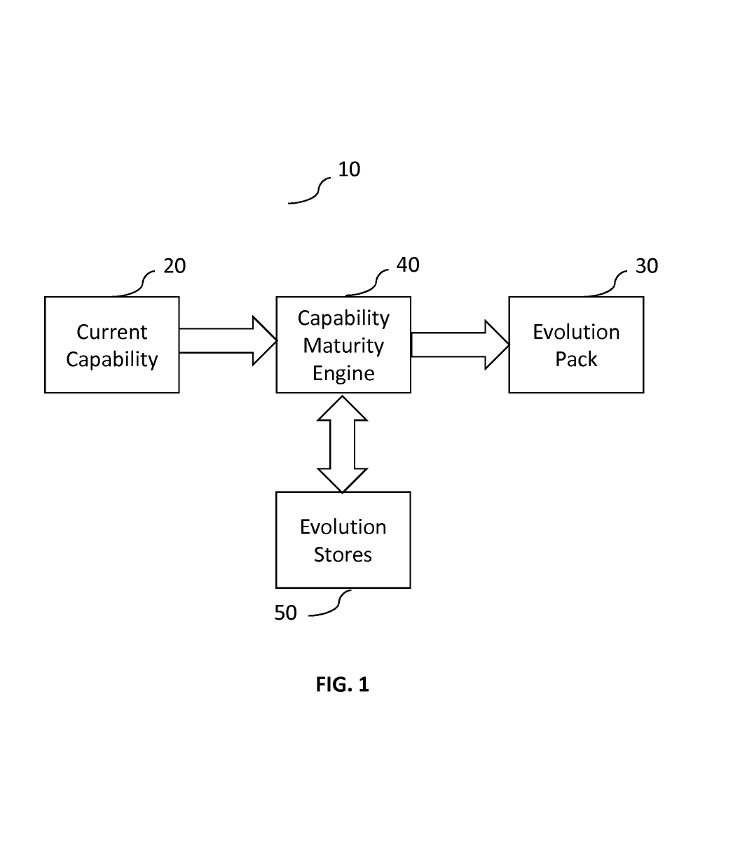

In its broadest sense, the process 10 as disclosed herein is represented in FIG. 1. In the process 10, current capability 20 can be evaluated and calculated to yield an output that, ultimately, identifies, outlines and produces an evolved pack 30 by operation of a capability maturity engine 40 with mediation by and input from an evolution stores module 50. Current capability 20 as the term is used in the present disclosure is a representation of the current state (or as-is) condition of people, process, and technology. The evolution pack 30 is a representation or quantification of a future state of people, process(es), and/or technology associated with the business under study. The evolved pack includes reports, recommendations and other output that allows the business to achieve evolved capability or capabilities. In certain embodiments, it is contemplated that the evolved pack will include at least one of an evolution roadmap and/or a current maturity diagram.

As used herein, the term “business” can include various for profit, not-for-profit enterprises as well as governmental and non-governmental entities. The term as used herein can also include various subgroups, units, subsidiaries, etc. Thus the business can be any enterprise or entity, either in whole or in part. In certain instances, it is contemplated that the analysis will be performed in a transaction in which the business or entity undergoing study is a client of an entity supervising and conducting the analysis. Thus the term terms “Business” and “Client” are maturity output to be considered interchangeable for purposes of this discussion unless otherwise indicated.

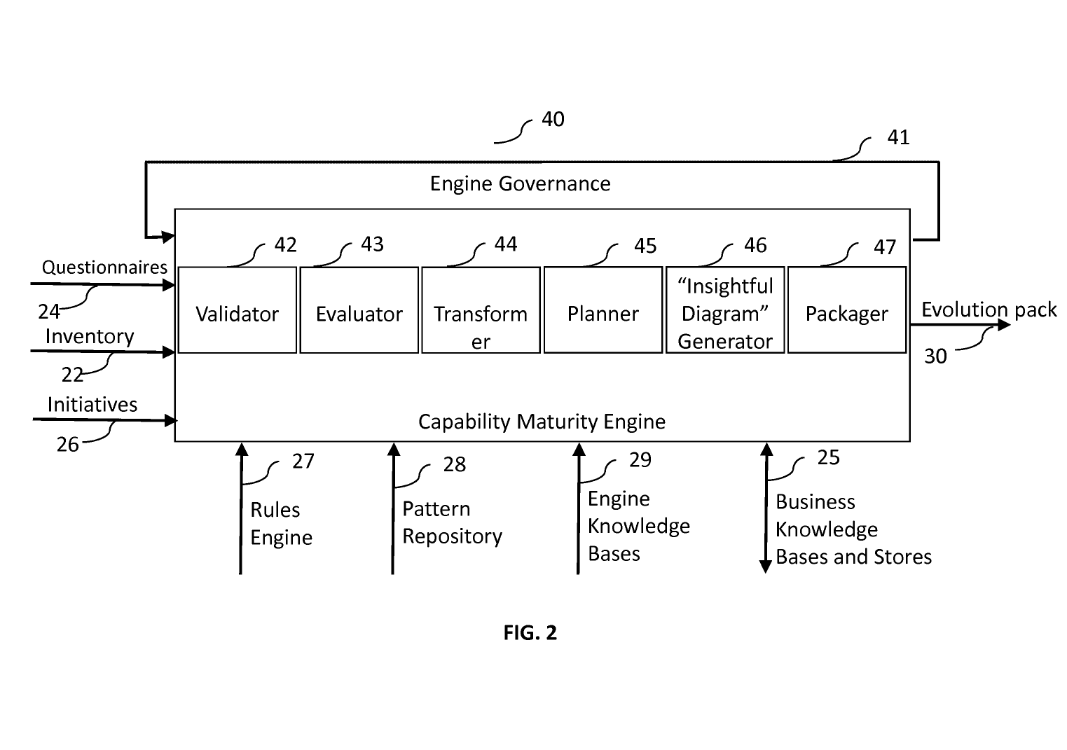

FIG. 2 illustrates an embodiment of capability maturity engine 40. In the embodiment as illustrated in FIG. 2. As illustrated in the embodiment in FIG. 2, current capability 20 is established or quantified by the integration of various selected input indicia into the capability maturity engine 40. Alternately, the various selected input indicia can be processed in a suitable pre-programmer (not-shown). Non-limiting examples of input indicia include inventory 22 or inventories of key indicators (for example information technology infrastructure, capital equipment, human resources, human resource skills and training, institutional knowledge, etc.), information from questionnaires 24 as well as information derived from initiatives 26.

The capability maturity engine 40 can also generate various outputs which can be transmitted as data pertaining to evolved capacity 30 and/or to an evolution pack operation 50.

The capability maturity engine 40 performs evaluation of current capabilities 20 and provides output values that quantize the evaluation. Here, inputs to the capability maturity engine 40 may include entity inputs, that is to say, information provided by the business entity that has the capabilities whose maturity is under consideration: information pertaining to inventory 22; and charter and capability maturity derived from assessment questionnaire information 24 and initiatives 26, as well as various other information provided (not shown) The input information can be provided and collected by the business under study or can be collected by a third party.

The operation of capability maturity engine 40 can also be influenced and mediated various processes and protocols including, but not limited, to rules engines information 27, pattern repository, 28, engine knowledge base(s) 29 as well as client (business) knowledge base(s) and store(s) information 25. Collectively such processes and protocols can be referred to as evolution pack 50.

The rules engine 27 may contain knowledge in the form of rules that assist the capability maturity engine 40 to make decisions on queries initiated in the capability maturity engine 40 such as queries contained in such as those called for by the transformer module 44 to execute transformer functions. A non-limiting examples of such queries answered by is whether a capability should be split into its constituent people, process, whether the technology under scrutiny can be also composed of sub-capabilities or the capability is already at an elementary or fundamental level and can no longer be decomposed. It is contemplated that relevant portions of information and data developed from inputs such as questionnaires 24, inventory 22, initiatives 26 etc., either as received or as processed by one or more modules of the capability maturity engine 40 can be added to the rules engine 27 to update the engine.

The pattern repository 28 may contain information related to capability decomposition. The term “capability decomposition” as used herein is directed to the analytical processes and rules which may be applied to reduce an identified or inputted capability or initiative into its relevant subcomponent and derived subcomponents to their substituent elements as applicable. It is contemplated that relevant portions of information and data developed from inputs such as questionnaires 24, inventory 22, initiatives 26 etc., either as ] received or as processed by one or more modules of the capability maturity engine 40 can be added to the pattern repository 28 to update the repository.

The engine knowledge bases 29 may contain standard information that relates capability maturation to identified business-related initiatives. It is contemplated that relevant portions of information and data developed from inputs such as questionnaires 24, inventory 22, initiatives 26 etc., either as received or as processed by one or more modules of the capability maturity engine 40 can be added to one or more of the engine knowledge bases 29 to update the same.

The client (i.e. business, or other, entity) knowledge bases and stores 25 may contain protocols pertaining to customizations of the standard information and information specific to a given entity's capabilities and initiatives. It is contemplated that relevant portions of information and data developed from inputs such as questionnaires 24, inventory 22, initiatives 26 etc., either as received or as processed by one or more modules of the capability maturity engine 40 can be added to one or more of the client knowledge bases and stores 25 to update the same.

The capability maturity engine 40 can also include one or more feedback paths 41. This is representative of the use of evaluation results which may also be used as inputs by which to improve the capability maturity engine 40 operation

As shall be described below and illustrated in FIG. 2, the capability maturity engine 40 may include one or more of the following: a validator module 42, an evaluator module 43, a transformer module 44, a planner module 45, current maturity diagram generator module 46, and a packager module 47. In the embodiment as depicted in FIG. 2, the maturity output diagram generator is referred to as an “Insightful Diagram” generator. “Insightful Diagram” is a trademark of Greater Brain Group referring to a specific current maturity output diagram. The various modules perform validations, evaluations, determine needed initiatives to address gaps, generate an informative diagram that provides insight, plan, and prepare the evolution package respectively, pursuant to operation of the capability maturity engine 40.

The validator module 42 validates incoming client (business, or other, entity) questionnaires 24, inventory 22 and initiative 26 information. The validator module 42 examines the information coming into the system and ensures that it conforms to the expected form and composition of information required for the capability maturity engine 40. It also applies the rules engine 24 to ensure that the information in the engine knowledge base(s) 29 and client (business, or other, entity) knowledge base(s) and store(s) 25 remain consistent and accurate.

The evaluator module 15 may generate evaluation data that includes measurement of various inputted information in terms of current capabilities and existing initiatives. It can apply changes in the inputted information coming that have been validated by the validator module 42 and can apply the rules engine 27 to the current engine knowledge base(s) 24 and client knowledge base(s) and store(s) 25 associated with and/or provided by the business under study in order to identify gaps in current capability maturity and associate each with initiatives identified in engine knowledge base(s) 24 that remedy the gap either partially or completely.

The transformer module 44 gathers the identified capability maturity gap initiatives as well as any initiatives that have been entered as part of the changes in the information coming into the system 10. These are integrated and combined with the generated initiative metrics to form a package of initiatives that can be conveyed to the planner module 45.

The planner module 45 operates on the data conveyed from the transformer module 44 to generate a plan that forms one of the output values generated by the capability maturity engine 40. In this operation, the planner module may use the various system produced and native initiative metrics that have been developed and identified in relation to business-specific constraint criteria including, but not limited to, effort, cost and value. This operation can occur in conjunction with planning rules derived from the engine knowledge base(s) 29 to arrive at the most efficient plan to satisfy the identified constraints.

The maturity output diagram generator module such as “Insightful Diagram generator 46 creates business-specific maturity output diagrams showing areas of maturity and areas where maturity is lacking. It is created from the capability maturity questionnaire response data and the questionnaire construction, which is linked to the capability people, process and technology information in the engine knowledge bases 29. The packager module 47 formats output value data and transmits the same into a maturity evolution pack module 50 to present the assessment findings. The maturity evolution pack generator 50 formats items such as the generated business-specific maturity output diagram and any associated data and conclusions derived from the diagram generator module 46, charter information collected during the assessment, and information from planner module 45. The maturity evolution pack generator module 50 includes architecture that can produce business-specific output that can include but is not limited to in the enterprise roadmaps, individual initiative project breakdowns in terms of dates, effort, costs and value, etc.

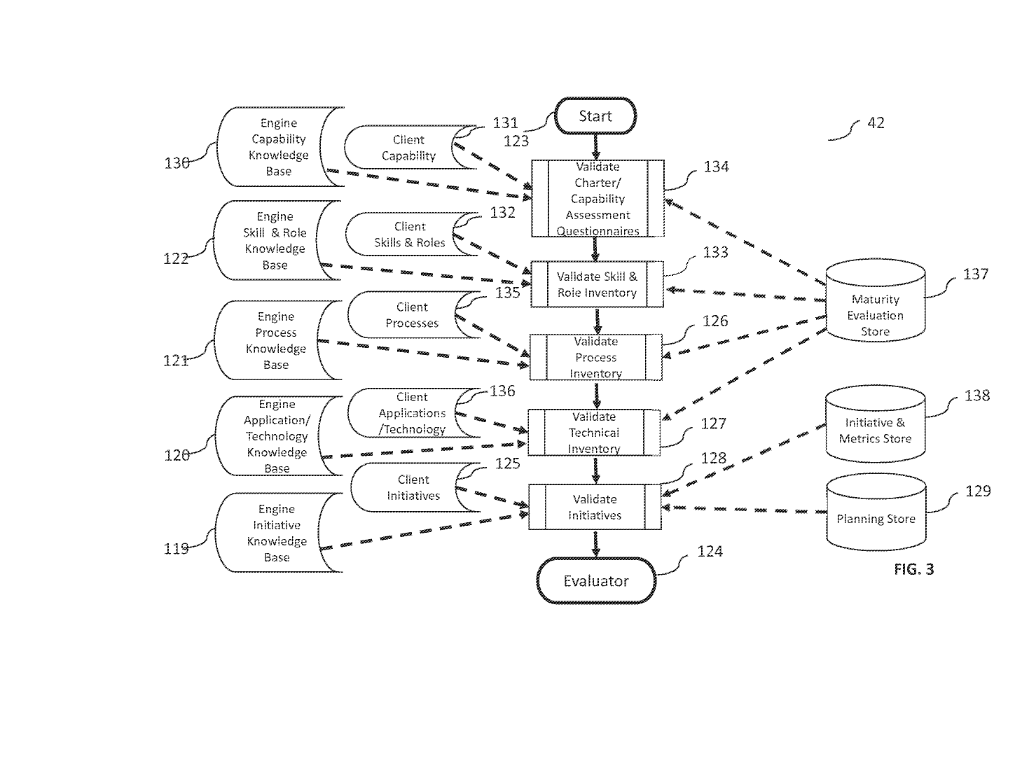

FIG. 3 is directed to an embodiment of the validator module 42 that can be included in the capability maturity engine 40 shown in FIG. 2. That validator module includes software and architecture suitable to ensure accuracy and functionality of the inputted data derived from information in the charter and questionnaire responses. The process implemented in the validator module 42 can include one or more stages. In the embodiment depicted in FIG. 3, the validation process may comprise five stages that are performed subsequent to start indicated by the start block 123.

In the process depicted in FIG. 3, validation of charter and capability assessment questionnaire response occurs at stage 134. Validation of skill(s) and role(s) progresses at stage 133. Validation of process inventory occurs at stage 126; while validation of technical inventory can occur at stage 127. Initiative validation can occur at stage 128. It is to be understood that the process, method, system and program as disclosed herein can include one or more of the aforementioned stages and that the various stages can include and execute programmed logic to execute the validation operations described. One or more of the various stages can be executed in any suitable order and sequence with one or more of the stages being executed simultaneous to one another.

New input information and knowledge base information sourced at the engine knowledge bases elements 119, 120, 121, 122, and 130, and client (business, or other, entity) knowledge bases and stores elements 125, 136, 135, 132, and 131, and maturity output evaluation information 137, initiative and metrics information 138, and plan information 129, are provided to the respective validation stages. Engine knowledge base elements 120, 121, and 122 contain the standard applications and technology 120, standard processes 121 and standard roles and skills associated with them 122, that are associated with the operation of the capability being assessed. Business knowledge bases and stores elements 136, 135, and 132 contain corresponding business customizations of the standard applications and technology 136, processes 135 and roles and skills associated with them 132.

New inventory information concerning applications and technology, processes, and roles and skills are supplied to stages 133, 126, and 127 respectively, where they may be checked against the corresponding engine knowledge bases elements 122, 121, and 122 respectively, and client (business, or other, entity) knowledge bases elements 136, 135, and 132 respectively, for conformity and client (business, or other, entity) stores element 137 for redundancy amongst instances.

Engine knowledge base element 130 contains the standard capability and sub-capabilities that are associated with the operation of the capability being assessed and are combinations of standard applications and technology 120, standard processes 121 and standard roles and skills associated with them 122. Business knowledge base element 131 contains corresponding business customizations of capability and business stores element 137 contains instances of capability inventory already collected. New charter and capability assessment questionnaire information concerning capability is supplied to stage 134, where it is validated against the corresponding engine knowledge bases element 130 and business knowledge bases element 131 for conformity and the business knowledge bases and stores element 137 for redundancy amongst instances. Engine knowledge bases element 140 contains standard initiatives and their metrics associated with the operation of the capability being assessed. Business knowledge bases and stores element 46 contains corresponding Business customizations of the standard initiatives. New information concerning initiatives is supplied to stage 128, where it is validated against the engine knowledge bases element 131 and business knowledge bases and stores element 146 for conformity and the business knowledge bases and stores elements 138 and 129 for redundancy amongst instances.

New information which causes existing information to become non-conformant or duplicated will be considered invalid. New information which is non-conformant will also be considered invalid, as will new information that references invalid information. Valid information will be provided to the evaluator stage 124 and invalid information will be rejected with indicia of the information rejected and diagnostic information about the reasons for rejection.

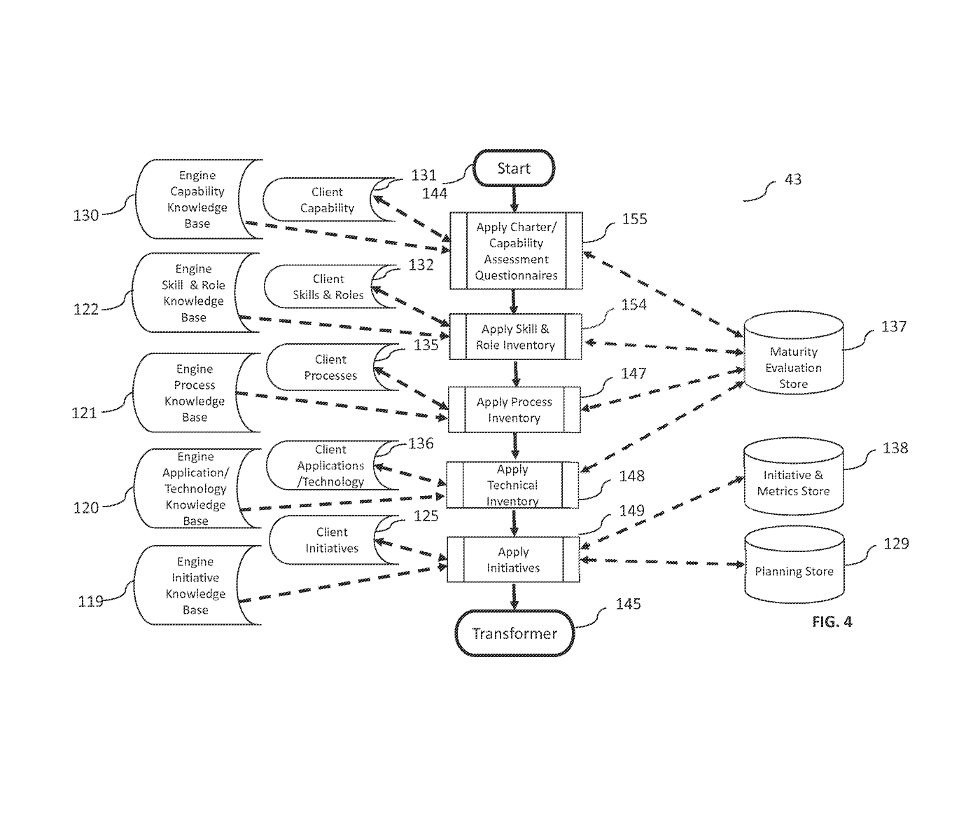

FIG. 4 is directed to an embodiment of the evaluator process module 43 of the capability maturity engine 40 as depicted in FIG. 2. In the embodiment as depicted, the evaluator process module 43 may have one or more stages. The embodiment as depicted in FIG. 4 comprises five stages of an evaluator process performed subsequent to start indicated by the start block 144, are shown. The stages may include one or more of the following: a step involving application of charter and capability assessment questionnaire response as at reference numeral 155, a step pertaining to an application of skill and role inventory as at reference numeral 154, a step involving to an application of process inventory as at reference numeral 147, a step involving an application of technical inventory as at reference numeral 148, and an initiative application step as at reference numeral 149.

New validated input information and knowledge base information sourced at the engine knowledge bases elements 119, 120, 121, 122, 130, and client knowledge bases and stores elements 125, 131, 132, 135 and 136, and information derived from current maturity evaluation store 137, initiative and metrics information store 138, and plan information derived from planning store 129, are provided to the application stages. Engine knowledge bases elements include at least one of those delineated at application/technology knowledge base 120, engine process knowledge base 121, and/or engine skill and knowledge base 122. The material included includes those that are associated with the business operation capability being assessed. Business knowledge bases and stores elements 157, 156, and 153 contain corresponding business customizations of the standard applications and technology 141, processes 142, and roles and skills associated with them 143. New validated inventory information concerning applications and technology, processes, and roles and skills are supplied at stages 154, 147, and 148 respectively, and may receive input from the corresponding engine knowledge bases elements 120, 121 and 122 respectively, and along with information about client applications/technology 136, processes 135, and skills and roles 132 respectively. Unmatched knowledge base information is added as customizations to the corresponding business or other entity knowledge bases elements as required.

All new validated inventory information concerning applications and technology, processes, and roles and skills are added to maturity evaluation store 137. Engine knowledge bases element 130 contains the standard capability and sub-capabilities that are associated with the operation of the capability being assessed and are combinations of standard applications and technology 120, standard processes 121 and standard roles and skills 122.

All new validated charter and capability assessment questionnaire information concerning capability is added to the maturity evaluation store 137 158. Engine knowledge bases element 119 contains standard initiatives and their metrics associated with the operation of the capability being assessed. Business knowledge bases and stores element 125 contains corresponding business customizations of the standard initiatives. New information concerning initiatives is supplied to stage 149, where it is matched against the engine knowledge bases element 119 and business knowledge bases and stores element 119. Unmatched knowledge base information is added as customizations to the corresponding business knowledge bases element 125. All new validated initiative information is added to the business knowledge bases and stores elements 138 for initiatives and their metrics, such as cost, effort and value, and element 129 for initiative planning.

Additionally, current maturity evaluation information 137, initiative and metrics information 138, and preliminary plan information 139, are provided to the transformer module 44. Maturity evaluation information 137 includes charter information. Non-limiting examples of charter information include but are not limited to one or more of the following: vision, mission, values, principles, strategy, goals, tactics, inhibitors and enablers for business context, capability and sub-capability, in terms of people, roles and skills, process, and technology, as applications and technology, mappings between actual business inventories corresponding to those capabilities. Capabilities can be linked to initiatives that address capability gaps, so that unachieved maturity can be linked to remedial actions. Initiative and metrics information 138 includes information such as effort, cost and value that enable initiatives to be quantified, prioritized and planned according to time and budgetary constraints and any dependencies between them. The initiatives for planning are held in the planning store 129.

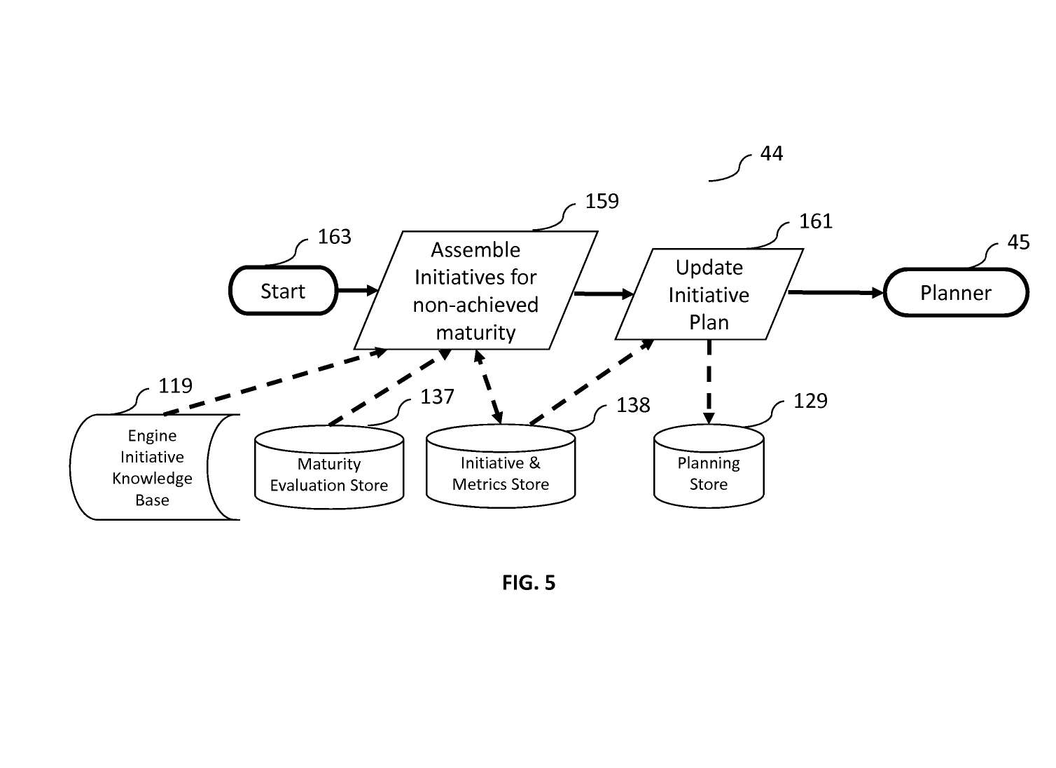

FIG. 5 is directed to an embodiment of an operation of the transformer module 44 of the capability maturity engine 40 shown in FIG. 2. Here, the two stages of the transformer process performed subsequent to start block 63 and prior to the end block at planner 45 are shown. The stages depicted are assembly of suggested initiatives to address non-achieved maturity stage at reference 159, and the updating of initiatives to pass for planning at reference numeral 161. The pattern repository 28 contains information related to capability decomposition. The engine knowledge bases 29 contain standard information that relates capability maturation to initiatives. The business knowledge bases and stores 25 can be configured to contain customizations of the standard information and information specific to a given entity's capabilities and initiatives.

The evaluator module 43 operates to apply charter and capability assessment questionnaire information at reference numeral 155 and processes information pertaining to business capability, sub-capability and initial maturity located in the Business Knowledge Bases and stores 25 into output including but not limited to initiatives to achieve maturation state that can be maintained in the maturity evaluation store 137.

Identified areas where maturity is lacking or underachieved can be further elucidated and initiatives developed for non-achieved maturity as at reference numeral 159. The process for assembling initiatives for non-achieved maturity 159 can include process steps in which missing or mismatched business capability located in the maturity evaluation store 137 is characterized and the remedial initiatives associated with each maturity gap are identified formulated and/or located in one or more of the associated databases. Once accomplished, the engine initiative knowledge base 119 is used to add the initiative and its metrics to the initiative and metrics store 138. At reference numeral 161, the process takes and processes initiatives added by stage 159 from the initiative and metrics store 138 and adds them to the planning store 129.

Additionally, initiative and metrics information maintained in the initiative and metrics store 138, and preliminary plan information maintained in the planning store 129 are provided to the planner module 45. Initiative and metrics contained in information and metrics store 138 can include but are not limited to quantification information such as effort, cost and value that enable various initiatives to be quantified as prioritized. Preliminary plan information maintained in planning store 129 includes but is not limited to the initiatives collected and queued to be planned as well as various relevant constraints, such as time and budget and dependencies between them.

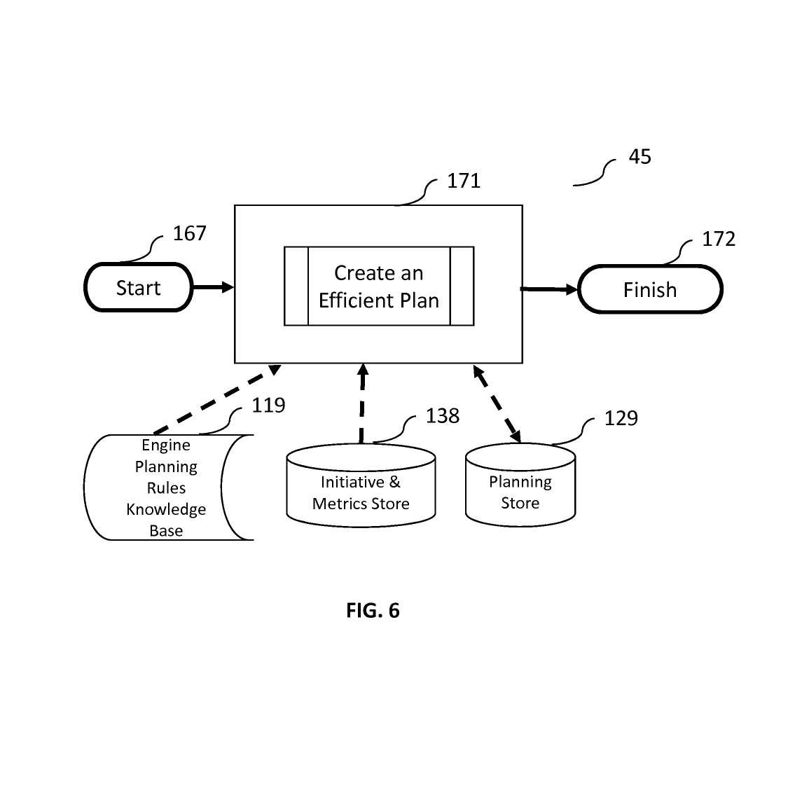

An embodiment of planner module 45 of the capability maturity engine 40 is depicted in FIG. 6. The embodiment of the planner module 45 executes planner processes performed subsequent to a start command indicated by the start block 167 and prior to the end block 172. Initiatives assembled for planning are promulgated in an efficient manner as at reference numeral 171 using planning rules derived from the knowledge base information as sourced at the engine knowledge bases elements 119. Non-limiting examples of knowledge base information can include the following: effort, cost and value. The plan assembler 171 also utilizes relevant data derived from initiative and metrics information maintained in the initiative and metrics store 138. Non-limiting examples of knowledge base information obtained from the business being studied include data and quantifiable values that enable initiatives to be quantified and prioritized. Such business-derived parameters may be held in the initiative and metrics store 169, while the initiatives to be planned, constraints, such as time and budget and the dependencies between them can be maintained planning store 129; which can be updated with the results of the operations of the planner module 45. Additionally, updated plan information promulgated by the planner module 45 is provided to the packager module by the business specific planning store 129.

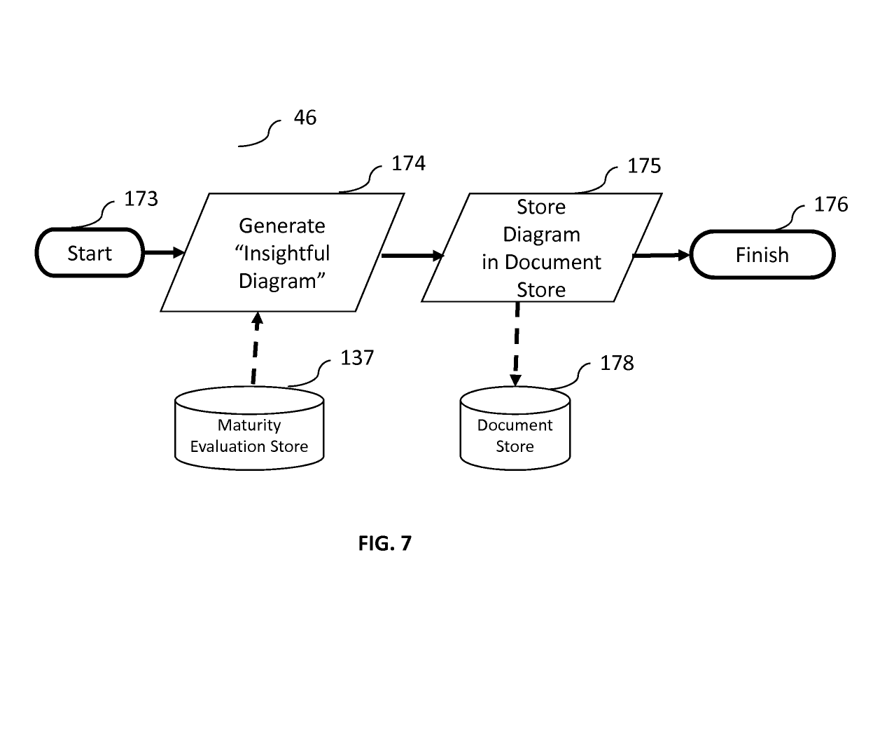

Generation of a business-specific maturity output diagram can be accomplished by insightful diagram generator module 46, a non-limiting example of the operation is illustrated in FIG. 7. An maturity output diagram, as that term is employed herein, describes, or otherwise identifies, the current maturity of a business or other entity under study; indicating areas of maturity that are lacking.

The maturity output diagram generator module can include multiple stages. In the embodiment as depicted in FIG. 7, the maturity output diagram generator module 46 includes at least two stages performed sequentially upon initiation of a start command as at start block 173 and concluding with an end command 176; namely, generation of the maturity output diagram such as an “Insightful Diagram” as at reference numeral 174, and its storage in a document store as at reference numeral 175. Business maturity evaluation store 137 is provided to the maturity output diagram generator stage 174. The maturity output diagram is generated by the transformation of the information in the capability maturity assessment questionnaire responses which are contained in the maturity evaluation store 137. Additionally, the generated maturity output diagram can be stored in the document store 178 and can be provided to the packager module 47.

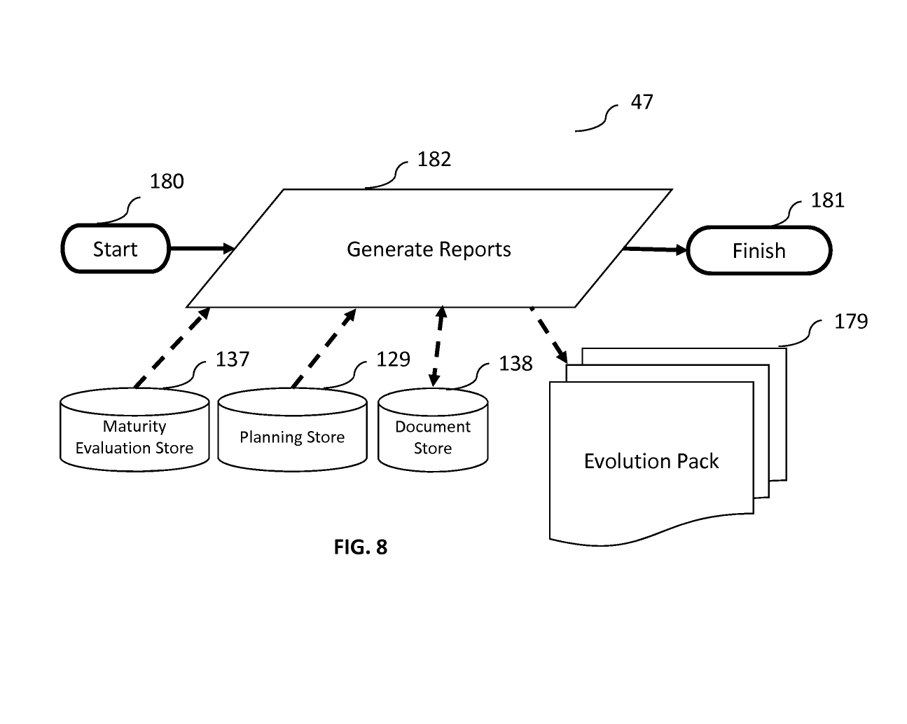

The process system and method 10 as disclosed herein may also include a packager module 47. An embodiment of the packager module and process is depicted in FIG. 8. Here, the packager process governed by packager module 47 and is performed subsequent to a start command indicated by the start block 180 and prior to an end command indicated by end block 81. Reports for the evolution pack are generated by module 182. Module 182 is configured to produce an output evolution pack 179 which can be incorporated into evolved or evolution pack 30. The output evolution pack 179 comprises reports that include but are not necessarily limited to the maturity output diagram highlighting unachieved capability maturity as generated by the maturity output diagram generator 46, charter information such as, vision, mission, values, principles, strategy, goals, tactics, inhibitors and enablers, a roadmap of recommended initiatives with dates and timelines, and information such as effort, cost and value, and activities for each initiative with information such as resource requirements, milestones, and deliverables. The output evolution pack can also include one or more roadmaps that outlined plans for future action, growth and evolution.

Business maturity evaluation stores 137 may contain the information for building the business-specific maturity output diagram, road maps, and charter reports. The planning store 127 can contain the information and execution operations associated with the roadmap and initiative reports such as the output evolution pack 179. It is generally considered that the output evolution pack 179 will be configured to include output configured to present findings to the business in a business useable form. Additionally, the reports for the evolution pack 179 are stored in the document store 178.

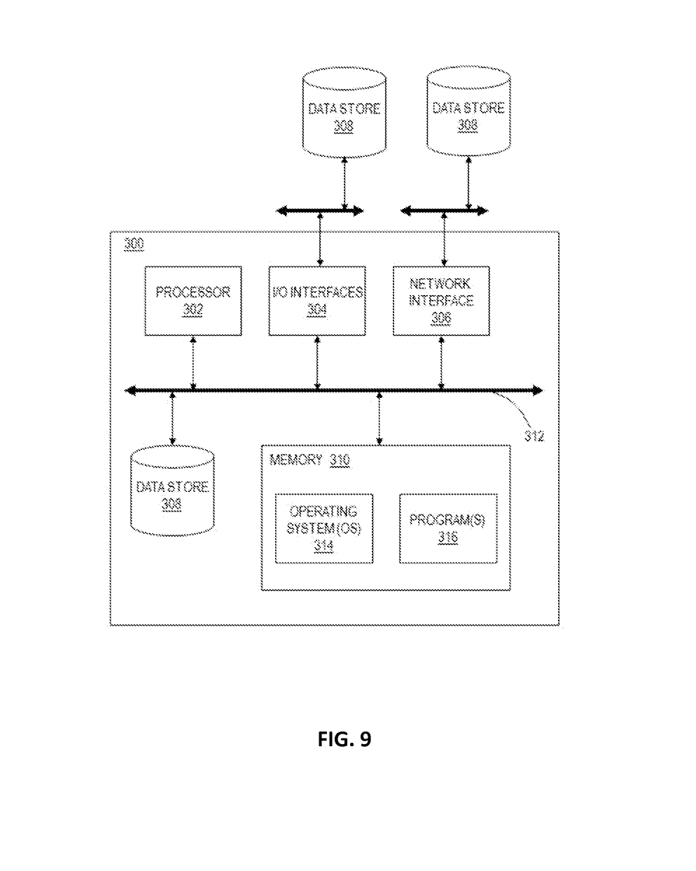

Referring now to FIG. 9, in an exemplary embodiment, a block diagram illustrates a server 300 which may be used to coordinate and run various modules and processes as described herein. The system may exist as part of one or more networks or operate in a standalone mode.

In certain applications, the server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 9 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 can be a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. It is also considered to be within the purview of this disclosure to execute discrete portions of the process 10 disclosed herein on multiple processors 302 in suitable electronic communication with one another.

When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

Network interface 306 may be used to enable the server 300 to communicate on a network, such as the Internet, the WAN 101, the enterprise 200, and the like, etc. The network interface 306 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 316. The operating system 314 essentially controls the execution of other computer programs, such as the one or more programs 316, and provides planning, input-output control, file and data management, memory management, and communication control and related services. The operating system 314 may be, for example Windows NT, Windows 2000, Windows XP, Windows Vista, Windows 7, Windows 8, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 316 may be configured to implement the various processes, algorithms, methods, techniques, etc. described herein.

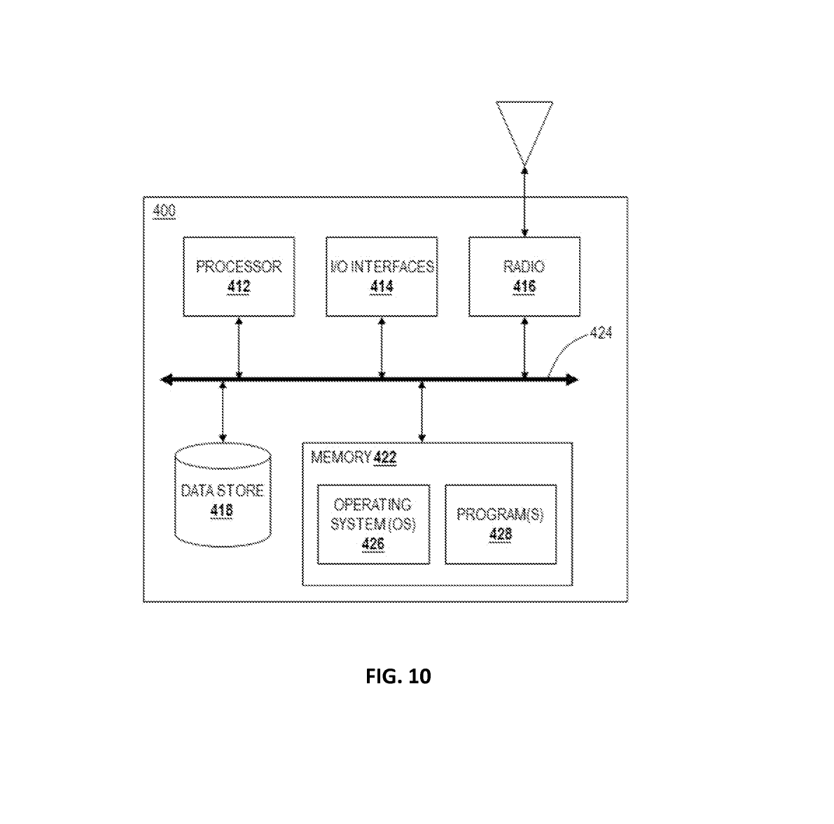

Referring to FIG. 10, in an exemplary embodiment, a block diagram illustrates a business or client device 400, which may be used to run various methods and processed described herein or to run aspects of the system or the like. The client device 400 can be a digital device that, in terms of hardware architecture, generally includes a processor 412, input/output (I/O) interfaces 414, a radio 416, a data store 418, and memory 422. It should be appreciated by those of ordinary skill in the art that FIG. 10 depicts the client device 410 in an oversimplified manner, and a practical embodiment may include additional components and suitably configured processing logic to support known or conventional operating features that are not described in detail herein. The components (412, 414, 416, 418, and 422) are communicatively coupled via a local interface 424. The local interface 424 can be, for example but not limited to, one or more buses or other wired or wireless connections, as is known in the art. The local interface 424 can have additional elements, which are omitted for simplicity, such as controllers, buffers (caches), drivers, repeaters, and receivers, among many others, to enable communications. Further, the local interface 424 may include address, control, and/or data connections to enable appropriate communications among the aforementioned components.

The processor 412 is a hardware device for executing software instructions. The processor 412 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 412 is configured to execute software stored within the memory 422, to communicate data to and from the memory 422, and to generally control operations of the client device 400 pursuant to the software instructions. In an exemplary embodiment, the processor 412 may include a mobile optimized processor such as optimized for power consumption and mobile applications. The I/O interfaces 414 can be used to receive user input from and/or for providing system output. User input can be provided via, for example, a keypad, a touch screen, a scroll ball, a scroll bar, buttons, bar code scanner, voice recognition, eye gesture, and the like. System output can be provided via a display device such as a liquid crystal display (LCD), touch screen, and the like. The I/O interfaces 414 can also include, for example, a serial port, a parallel port, a small computer system interface (SCSI), an infrared (IR) interface, a radio frequency (RF) interface, a universal serial bus (USB) interface, and the like. The I/O interfaces 414 can include a graphical user interface (GUI) that enables a user to interact with the client device 400. Additionally, the I/O interfaces 414 may further include an imaging device, i.e. camera, video camera, etc. The radio 416 enables wireless communication to an external access device or network. Any number of suitable wireless data communication protocols, techniques, or methodologies can be supported by the radio 416, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 418 may be used to store data. The data store 418 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 418 may incorporate electronic, magnetic, optical, and/or other types of storage media. In some preferred embodiments, the client device 400 includes a global positioning system sensor configured to receive latitude and longitude coordinates from satellites (i.e. a GPS signal).

In some other preferred embodiments, the client device 400 includes an accelerometer configured to receive user initiated actions (e.g. shaking the device, moving the device in a pattern, etc.

The memory 422 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 422 may incorporate electronic, magnetic, optical, and/or other types of storage media. Note that the memory 422 may have a distributed architecture, where various components are situated remotely from one another, but can be accessed by the processor 412. The software in memory 422 can include one or more software programs, each of which includes an ordered listing of executable instructions for implementing logical functions. In the example of FIG. 4, the software in the memory system 422 includes a suitable operating system (O/S) 426 and programs 428. The operating system 426 essentially controls the execution of other computer programs, and provides planning, input-output control, file and data management, memory management, and communication control and related services. The operating system 426 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 428 may include various applications, add-ons, etc. configured to provide end user functionality with the client device 400. For example, exemplary programs 428 may include, but not limited to, a web browser, social networking applications, streaming media applications, games, mapping and location applications, electronic mail applications, financial applications, and the like. In a typical example, the end user typically uses one or more of the programs 428 along with a network such as the system.

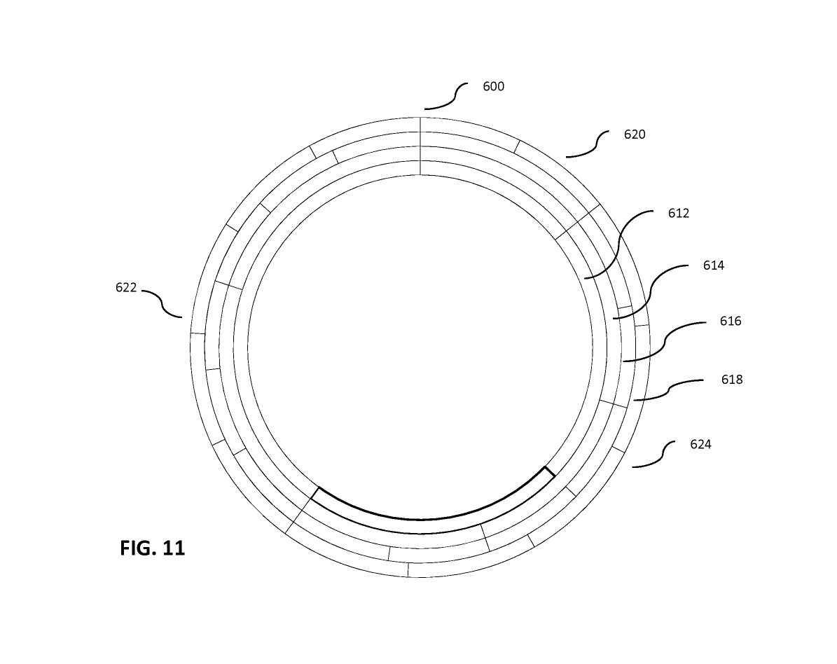

The maturity output diagram, as the term is employed herein, is a diagrammatic representation of evolved capability output as a matrix of capacity levels cross indexed against at least one business-associated attribute. A non-limiting example of a maturity output diagram is depicted in FIG.11. It is to be understood that a maturity output diagram as produced by the process disclosed herein will include a geometric or tabular representation that relates capabilities and attributes present in a business under study and the relative maturity associated with each reported attribute and capability.

The maturity output diagram that is produced can have any suitable geometric shape as desired. In the embodiment depicted in FIG.11, the representation of the report of the evolved capability of the business or business entity under study is presented as a maturity output diagram 600 that includes a plurality of concentric circles 610, 612, 614, and 616 respectively that progress from interior to exterior. The concentric circles business capacity or potential business capacity of the business or entity under examination and study. Capability as represented can be defined as evidence of some set of organizations governance of one or more of the various activities occurring in the business unit.

In the embodiment disclosed herein, the interior circle 612 corresponds to ad hoc capacity. As employed herein, the term “ad hoc capacity” is defined as a collection of minimal or threshold skills and capabilities required to maintain the business enterprise on mission. Ad hoc capacity can be derived from information collected regarding activities, responses, processes, performance and resources that can be evaluated or quantified against attributes or capabilities generally evidenced by existing businesses operating at a basic level. In the process and method as disclosed herein, information and data derived from the various questionnaires that have been described previously in the present disclosure, as well as information obtained from other sources can be deconstructed and assigned suitable analytical value ; for example numeric value. Responses and coordinated data that is assigned minimum values will be assigned to circle 612 as appropriate.

Directly exterior to the ad hoc capability circle 612 is the emergent capability circle 614. Various activities exhibited by the business that can be assigned greater maturity value can be identified and the associated output data can be directed to populate the emergent capability circle 614. As used herein, the term “emergent capability” can be broadly defined as attributes and capabilities typically associated with more robust on-going businesses or enterprises. Typically in capabilities present in the emergent capability circle will evidence a degree of coordination and governance regarding following and executing the same rules.

Similarly, a circle 616 located external to the emergent capability circle 614 will be populated by higher value responses representing managed capability. As use herein the term “managed capability” can be used to define an organization or sub-organizations in which governance and systems are applied consistently for a given capability. Best practice disciplines are aspired to and in some cases adopted. These can include, but are not limited to, attributes, activities and outcomes that can be benchmarked against relevant industry standards as evidenced by appropriate analogous portions of entities in the relevant business pool.

The exterior circle 618 as depicted in FIG. 11 is configured to be populated by any high value responses evidencing highest value or optimized capability. As used herein the term “optimized capability”. Attributes of practices, capacities and capabilities present in the optimized capability level are those that evidence interest in utilization efficiency and consistency in capturing system and organizational learnings and self-analysis with a goal to providing lessons learned in other areas. When benchmarked against relevant industry standards, these capabilities are typically evidenced in highly functional mature entities. It is contemplated that standards associated with the various capability benchmarks that can be maintained in a suitable accessible storage location in the associated program.

The maturity output diagram 600 is also configured to receive attribute-specific data. In the embodiment depicted in FIG. 11, the maturity output diagram includes a plurality of attribute regions 620, 622, 624 that correspond to key ability groups associated with the business under study. In certain embodiments, the regions 620, 622, 624 are related to human resource attributes, technological attributes and process attributes, respectively. The relative areas of the respective regions are assigned based upon business specific factors including, but not limited to, the nature of the specific business being studied and/or analyzed. Thus the relative area assigned to a given region can be calculated based on the responses to questionnaires and other inputs such as charter documents etc. In certain embodiments, it is contemplated that the relative attribute data can be assigned as suitable geo-location value that links each discrete attribute to a location a given capacity/maturity ring. This can be accomplished by suitable program logic resident in the program and/or associated with the process described herein. It is also within the purview of this disclosure that the value of each attribute can be assigned a numeric or other value within a defined value continuum. The process disclosed herein can include suitable program logic to determine whether a given attribute region on a capacity ring should be fully or partially filled in.

Thus, information obtained by questionnaire and other investigation can be converted into data that can be rated and valued for position on a location on a ring within a specified region on the maturity output diagram, Based upon the value assigned to the given data, it is contemplated that the location can be fully or partially populated. The resulting report will be a visual graphic which may identifies the level of achievement of the given attribute through full or partial filling of the assigned grid space.

Non-limiting examples of human resources attributes that may be analyzed and reported include enterprise governance roles, level of individual worker concern and commitment, presence or absence of an enterprise governance council, presence or absence of business driver as well as strategy and delivery. Non-limiting examples of process attributes include the presence or absence of manual cleansing and/or manual improvements, quantification of poor quality effect, creation of reusable governance processes, presence or absence of integration initiatives, education and training enterprise standards, quality and security of stewards, development by infrastructure and metrics, monitoring and auditing practices, the presence or absence of continuous automated management processes, presence or absence of standards development, presence or absence of charter and or roadmap projects, etc. Non-limiting examples of technology attributes include presence or absence of non-standard cleansing tools, presence or absence of application tools addressing quality and/or performance quality tools, presence or absence of meta-data management tools, presence or absence of data development tools, operational management tools data security tools, integration tools, master data management process automation and the like.

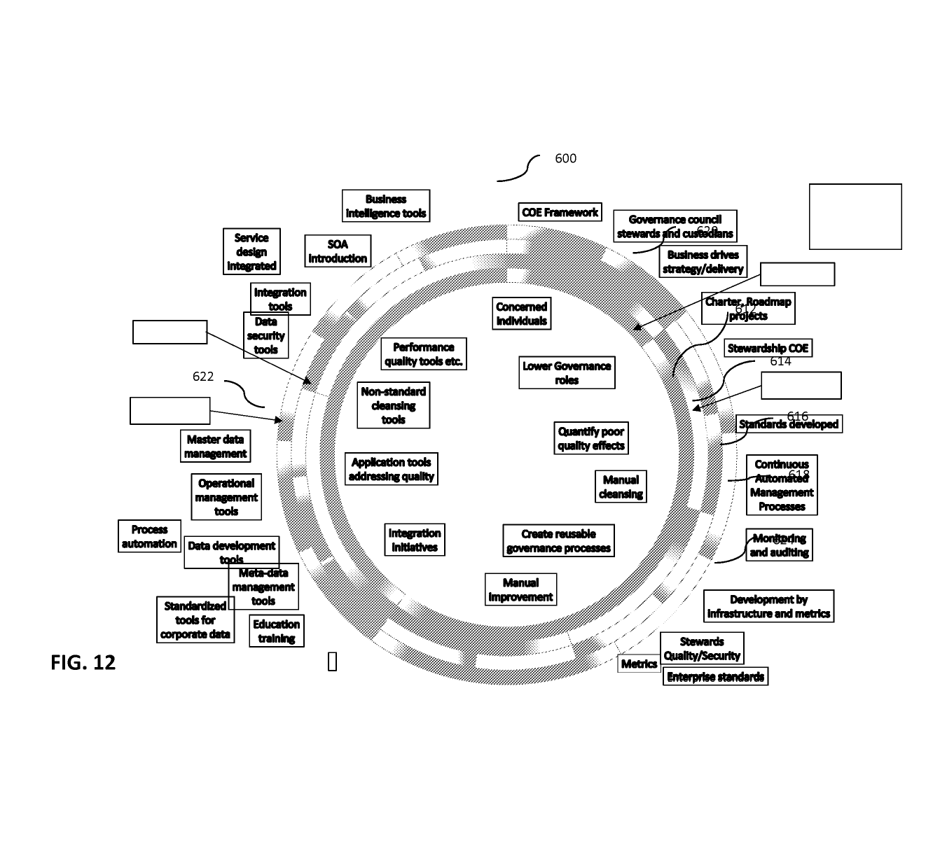

It is to be understood that generation of the maturity output diagram as disclosed herein can occur by various hierarchical protocols. In the embodiment disclosed herein, identification of one or more higher maturity attributes results in an output that provides a visual indicator located in the higher maturity circle but does not trigger output into corresponding attribute locations in lower maturity circles. In the embodiment disclosed herein, lower maturity attributes that are not identified in the questionnaires and other inputs remain unfilled thus yield an output diagram with capacity, attributes and maturity outlined with visual indicators of gaps in capacity, attributes and maturity relative to the business under study. One representative diagram is depicted in FIG. 12.

In certain embodiments of the process and method as disclosed herein, the step of analyzing assessed information associated with the current state of business maturity can include the step of referring to and assessing inputted information data. The process may also include the step of analyzing differences between the current state and desired future state levels of maturity and performance with the at least one capability assessed for a current level of maturity and performance, using current or historical evolution assessments resident in the process. Where desired or require, the process or method disclosed herein may include the step of analyzing the evolution maturation needed to achieve a desired future state of maturity and performance of at least one capability assessed for current level of maturity and performance, using the current or historical evolution assessments inputted in the process.

Where desired or required, business-specific capability and relationships include at least one of the following: current and historical capability information regarding people involved, skills and organization, processes employed, best practice, and technology utilized. Where desired or required, business-specific capability and relationships may include at least one of the following: current and historical capability information regarding people involved, skills and organization, processes employed, best practice, and technology utilized. Where desired or required, business specific capability data may include at least one of the following: reference architectures, maturity performance measurements, maturity performance measurements analytics. Similarly, wherein desired or required, business specific capability maturity evolution data may include at least one of the following: includes at least one of the following: remedial initiatives, plans, metrics, budgets, roadmaps, schedules and motivational behavioral modifiers, influences, requirements, standards, regulatory frameworks.

While the invention has been described in connection with what is presently considered to be the most practical and preferred embodiments, it is to be understood that the invention is not limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for assessing at least one capability and operational maturity possessed by a business entity, the method comprising the steps of:
providing a capability and business evolution processing program that is resident on a processor computer having a server and a data storage device, the capability and business evolution processing program including an evaluation engine;
integrating information gathered regarding current capability of a business or at least one business unit into the evaluation engine, wherein the evaluation engine assesses inputted information based on at least one capability criteria;
producing at least one output the indicates evolved capability value, wherein said evolved capability value is either produced directly from the evaluation engine or is mediated by at least one evolution evaluator assessment tool that is resident in the evaluation engine;
transferring the output to a business-specific report, the report including at least one of the following: maturity output diagram, a business-specific action recommendation output.

2. The method of claim 1 wherein the current maturity diagram includes a matrix having at least one region associated with at least one of the following: ad hoc capacity, emergent capacity, managed capacity and optimized capacity cross-indexed against at least one attribute selected from at least one of the following: process attributes, technology attributes, human resource attributes.

3. The method of claim 1 wherein information gathered is directed to at least two capabilities wherein the capabilities include at least one of the following: business performance metrics and scores, business-roles and associated skills, business processes, business-specific applications and/or technology, current business initiatives.

4. The process of claim 3 further comprising the step of:
gathering information applicable each capability to be assessed, capability maturity and capability evolution characteristics, wherein at least a portion of the information is gathered prior to the integration step; and
assessing at least one capability for its current level of maturity and performance, and for desired future state of evolution, wherein the assessing and gathering steps occur prior to the integrating step;
analyzing assessed evolution maturation required to achieve at least one target goal, wherein the at least one target goal includes at least one desired future state, the desired future state derived from current and/or historical evolution assessments resident in a an evolution pack;
producing at least one output recommendation outlining at least one evolution maturation path and at least one aspect in which further maturation information is required wherein the at least one output recommendation includes information contained the current maturity diagram;
producing at least one output indicator of evolved capability value, wherein the at least one output indicator is contained in the current maturity diagram.

5. The process of claim 3 further comprising the step of:
analyzing evolution maturity necessary to achieve a target business capability state, the analysis step integrating at least one of current business maturity level, current business performance level, desired business maturity level, desired business maturity performance, wherein the analysis step further integrates at least one capability.

6. The method of claim 4 wherein the step of gathering information is directed to each capability to be assessed, business maturity and evolution characteristics, wherein the gathering step comprises the steps of:
inputting at least one of the following:
a. business specific capability and relationship information from at least one source, wherein the business specific information relates or is relatable to at least one of the following: ad hoc capability, emergent technology capability, managed technology capability and optimized technology capability;
b. business specific capability maturity data applicable to the business specific capability information;
c. business specific capability maturity evolution information data; and p1 encoding business-specific capability information and relationships and business-specific capability maturity data applicable to each capability under study.

7. The method of claim 6 wherein business-specific capability and relationships include at least one of the following: current and historical capability information regarding people involved, skills and organization, processes employed, best practice, and technology utilized.

8. The method of claim 6 wherein business specific capability data includes at least one of the following: reference architectures, maturity performance measurements, maturity performance measurements analytics.

9. The method of claim 6 wherein business specific capability maturity evolution data includes at least one of the following: includes at least one of the following: remedial initiatives, plans, metrics, budgets, roadmaps, schedules and motivational behavioral modifiers, influences, requirements, standards, regulatory frameworks.

10. The method of claim 6 wherein the step of analyzing assessed information associated with the current state of business maturity comprises the steps of:
referring to and assessing the inputted information data;
analyzing differences between the current state and desired future state levels of maturity and performance, the at least one capability assessed for a current level of maturity and performance, using current or historical evolution assessments resident in the process;
analyzing the evolution maturation needed to achieve a desired future state of maturity and performance of at least one capability assessed for current level of maturity and performance, using the current or historical evolution assessments inputted in the process.

11. The method of claim 10 wherein the step of producing at least one output comprises:
matching evolution maturation needs to achieve the desired future state of maturity and performance with the differences between the current state and desired future state levels for the capability or capabilities assessed for their current level of maturity and performance, using the current or historical evolution assessments resident in an evolution pack;
determining and encoding matched evolution needs;
generating at least one report that outlines gaps and alternatives in evolution maturation needs for differences between the current state and desired future state levels for the at least one capability assessed for current maturity level and performance, wherein the report utilizes the current or historical evolution assessments resident in an evolution pack.

12. The method of claim 4 wherein the transferring step comprises:
producing an current maturity diagram that presents the current and desired capability maturity, highlighting areas where maturity is lacking; and
producing strategic planning information to address gaps in the current and desired capability maturity.

13. The method of claim 11 wherein the step of producing at least one output includes producing at least one output indicator of evolved capability value directly from the capability generator or mediated by it and producing strategic planning information to address gaps in the current and desired capability maturity by using the evolution maturation needs.
